(19) United States
(12) Patent Application Publication
(10) Pub. No.: US 2026/0140031 A1
(43) Pub. Date: May 21, 2026

(54) TEST DEVICE AND METHOD FOR SIMULATING TUNNELING OF DUAL-CHAMBER SLURRY PRESSURE BALANCE (SPB) SHIELD UNDER HYPER-GRAVITY

(71) Applicant: ZHEJIANG UNIVERSITY, Hangzhou (CN)

(72) Inventors: Yanbo CHEN, Hangzhou (CN); Daosheng LING, Hangzhou (CN); Yandong LV, Hangzhou (CN); Xiaowei YE, Hangzhou (CN); Hao LIU, Hangzhou (CN); Zixuan LI, Hangzhou (CN); Minghang ZOU, Hangzhou (CN); Zhongduo LV, Hangzhou (CN)

(73) Assignee: ZHEJIANG UNIVERSITY, Hangzhou (CN)

(21) Appl. No.: 19/450,760

(22) Filed: Jan. 16, 2026

Related U.S. Application Data
(63) Continuation of application No. PCT/CN2024/139006, filed on Dec. 13, 2024.

(30) Foreign Application Priority Data
Sep. 10, 2024 (CN) 202411263567.8

(51) Int. Cl. G01N 11/04

(52) U.S. Cl. CPC G01N 11/04

(57) ABSTRACT

A test device for simulating tunneling of a dual-chamber slurry pressure balance (SPB) shield under a hyper-gravity includes a soil box, a shield body, a shield power system, and a slurry feed-discharge system. The shield body and the slurry feed-discharge system are fixed through a bottom plate, and placed on a geotechnical centrifuge; the soil box is connected to the shield power system through the shield body; the shield body is further connected to the slurry feed-discharge system; a front bulkhead is configured to divide a working chamber into a slurry chamber and an air cushion chamber; the shield power system is configured to drive a cutterhead to rotate, and to drive a main shaft to tunnel forward; and the slurry feed-discharge system is configured to feed slurry to the slurry chamber and the air cushion chamber and discharge muck.

### CROSS REFERENCE TO THE RELATED APPLICATIONS

This application is a Continuation application of International Application No. PCT/CN2024/139006, filed on Dec. 13, 2024, which is based upon and claims priority to Chinese Patent Application No. 202411263567.8, filed on Sep. 10, 2024, the entire contents of which are incorporated herein by reference.

### TECHNICAL FIELD

The present disclosure belongs to the field of model tests on slurry pressure balance (SPB) shields, and in particular to a test device and method for simulating tunneling of a dual-chamber SPB shield under a hyper-gravity.

### BACKGROUND

SPB shield tunneling serves as a common construction method for cross-river and cross-ocean tunnels. Pressurized slurry permeates strata to form a filter cake on the excavation face. The slurry pressure acts on the filter cake in the form of a surface force, so as to balance a lateral soil-water pressure ahead of the excavation face and to maintain stability of the excavation face. A support pressure of the dual-chamber SPB shield is dominated by air pressure and will not experience significant fluctuations due to factors such as changes in slurry density. Therefore, compared with the single-chamber SPB shield, the support pressure of the dual-chamber SPB shield is controlled more easily during tunneling.

At present, most tunneling tests on the SPB shields are conducted under normal gravity. However, since the tests under the normal gravity cannot reproduce the real stress level of the stratum and the real scale of the shield, whether the simulated excavation process and excavation face instability mode of the SPB shield are consistent with actual working conditions cannot be determined. Geotechnical centrifugal modeling is an effective method to reproduce stress levels of large-scale media using small-scale media under normal gravity. It solves the problem of stress field dissimilarity, and can reproduce the real soil stress level and water pressure outside a slurry chamber as well as the gradient-distributed slurry pressure inside the slurry chamber by creating a hyper-gravity environment. This method makes it possible for the SPB shield to simulating the excavation process and excavation face instability mode. However, the slurry is prepared from bentonite and water that have different densities. When a hyper-gravity centrifuge increases the gravitational field strength, the relative driving force between the two substances is intensified, thereby accelerating their phase separation. As a result, the slurry has an uneven density, and the actual permeation mode of the slurry and the type of the filter cake cannot be simulated. Since the hyper-gravity will aggravate sedimentation of muck excavated by the shield and blockage of the tubes, the slurry discharge flow is hardly controlled, and the slurry pressure cannot be accurately controlled. Therefore, in order to research complex strata with great buried depths and high water pressures and solve the above problems, how to reproduce the excavation process of the SPB shield, and grasp the control mechanism on the support pressure of the dual-chamber SPB shield has become an urgent problem to be solved.

### SUMMARY

In view of problems in the background, an objective of the present disclosure is to provide a test device and method for simulating tunneling of a dual-chamber SPB shield under a hyper-gravity. The present disclosure solves the problem that since the hyper-gravity will aggravate sedimentation of muck excavated by the shield and blockage of the tubes, the slurry discharge flow is hardly controlled, and the slurry pressure cannot be accurately controlled.

The present disclosure adopts the following solutions:

A first aspect of the present disclosure provides a test device for simulating tunneling of a dual-chamber SPB shield under a hyper-gravity, including:
a soil box, a shield body, a shield power system, and a slurry feed-discharge system, where a soil mass is stored in the soil box; the soil box is connected to the shield power system through the shield body; the shield power system is configured to drive the shield body to move back and forth along a tunneling direction, such that the shield body performs tunneling on the soil mass in the soil box; the shield body is connected to the slurry feed-discharge system; a pressure maintaining system configured to balance air pressure in the shield body is disposed in the shield body; the soil box, the shield power system, and the slurry feed-discharge system are fixed on a bottom plate; and the bottom plate is placed into a basket of a geotechnical centrifuge.

The shield body includes a chamber housing internally provided with a working chamber, a cutterhead, a front bulkhead that is annular, and a main shaft; the front bulkhead is located in the chamber housing, and configured to divide the working chamber into a slurry chamber and an air cushion chamber; the cutterhead is located on a side close to the slurry chamber; one end of the main shaft is connected to the shield power system; another end of the main shaft is coaxially connected to the cutterhead after sequentially passing through the air cushion chamber, the front bulkhead, and the slurry chamber; an end of the chamber housing provided with the slurry chamber is movably connected to an opening of the soil box, and can move back and forth relative to the opening of the soil box; an end of the chamber housing provided with the air cushion chamber is fixedly connected to the shield power system; the shield power system is configured to drive the cutterhead to rotate, and to drive the main shaft to axially tunnel forward; both the slurry chamber and the cutterhead are disposed at the opening of the soil box; a connecting tube is connected to the front bulkhead; the connecting tube is configured to transmit the pressure in the air cushion chamber to the slurry chamber; and the shield power system is controlled in a closed-loop manner through a servo valve.

The slurry feed-discharge system includes a slurry box, a slurry pump, a muck box, a separation box, and a screw conveyor; the slurry pump is connected to an output end of the slurry box; the slurry pump communicates with the slurry chamber through a first slurry inlet tube; the slurry pump communicates with the air cushion chamber through a second slurry inlet tube; a first solenoid ball valve and a second solenoid ball valve are respectively disposed on the first slurry inlet tube and the second slurry inlet tube; one end of a first overflow tube extends into the slurry chamber through the air cushion chamber and an opening in the front bulkhead; another end of the first overflow tube communicates with the atmosphere; one end of the second overflow tube extends into the air cushion chamber; another end of the second overflow tube communicates with the atmosphere; a third solenoid ball valve and a fourth solenoid ball valve are respectively disposed on the first overflow tube and the second overflow tube; a bypass tube is further disposed between the slurry box and the slurry pump; the bypass tube includes one end connected to the slurry box, and another end communicating with the slurry pump, the first slurry inlet tube, and the second slurry inlet tube; and a bypass ball valve is disposed on the bypass tube; and
the screw conveyor includes one end extending into the slurry chamber, and another end connected to the muck box through a tube; a sixth solenoid valve, the separation box, and a changeover valve block are sequentially disposed on a tube from the screw conveyor to the muck box; and the slurry pump is powered by hydraulic pressure of the geotechnical centrifuge.

The changeover valve block mainly includes two branch tubes, a muck inlet tube, and a muck outlet tube; one end of the muck inlet tube is connected to the separation box; another end of the muck inlet tube is connected to input ends of the two branch tubes; output ends of the two branch tubes are connected to one end of the muck outlet tube; another end of the muck outlet tube is connected to the muck box; a seventh solenoid valve and a damper are respectively disposed on the two branch tubes; and a second electromagnetic flowmeter is disposed on the muck outlet tube; and
a slurry discharge flow in the muck outlet tube is obtained by:

$$Q = {C}_{d} A \sqrt{\frac{2 Δ P}{{ρ}_{d}}}$$

where [symbol] denotes the slurry discharge flow, C_{d} denotes a damping coefficient of the damper, A denotes a cross-sectional area of the muck outlet tube, ΔP denotes a pressure drop, and ρ_{d} denotes a density of slurry mixed with muck.

Three layers of filter screens with different pore sizes are disposed in the separation box; an axial direction of each of the three layers of filter screens is perpendicular to a slurry flow direction; slurry output by the screw conveyor flows from an input end of the separation box, is sequentially filtered by the three layers of filter screens, and flows out from the separation box; the pore sizes of the three layers of filter screens are sequentially decreased in a direction from an inlet to an outlet of the separation box; and a pore size of a third layer of filter screen is less than a maximum particle size for a second electromagnetic flowmeter.

A relationship between slurry pressure and soil-water pressure at an excavation face of the shield body is expressed as:

$${P}_{g} + {ρ}_{s} g ( h - D + z ) \geq {γ}_{w} ( H + z ) + {K}_{a} {γ}^{′} ( H + z )$$

$${P}_{g} + {ρ}_{s} g ( h - D + z ) \leq {γ}_{w} ( H + z ) + {K}_{p} {γ}^{′} ( H + z )$$

where P_{g} denotes air pressure, ρₛ denotes a slurry density, g denotes a gravitational acceleration, h denotes a liquid level of the air cushion chamber, D denotes a shield diameter, z denotes a vertical coordinate of the excavation face, γ_{w} denotes a specific weight of water, H denotes a shield top buried depth, γ′ denotes an effective specific weight of soil, Kₐ denotes an active earth pressure coefficient, and Kₚ denotes a passive earth pressure coefficient.

A thrust F_{d} and a torque T provided by the shield power system are obtained by:

$${F}_{d} = {F}_{1} + {F}_{2} = \frac{π}{4} {D}^{2} K γ ( H + \frac{D}{2} ) + f γ D [ \frac{π}{2} ( 1 + K ) ( H + \frac{D}{2} ) - \frac{1}{3} D ( 2 + K ) ] L + fLW$$

$$T = {T}_{1} + {T}_{2} = \frac{π}{12} {D}^{3} Kf γ ( H + \frac{D}{2} ) ( 1 - {η}^{2} ) + \frac{π}{4} {D}^{2} ( 1 + K ) f γ ( H + \frac{D}{2} ) W + {KP}_{0} \frac{{D}^{2}}{8} p$$

where F₁ denotes a front propulsive resistance during shield tunneling, F₂ denotes a frictional force between a shield shell and a surrounding soil mass, K denotes a lateral earth pressure coefficient, γ denotes a specific weight of soil, f denotes a frictional coefficient between the shield shell and the surrounding soil mass, L denotes a length of a shield tunneling machine, W denotes a dead weight per unit length of the shield tunneling machine, T₁ denotes a frictional resistance torque between the cutterhead and the soil mass, T₂ denotes a stratum resistance torque when the cutterhead cuts the soil mass, η denotes an opening ratio of the cutterhead, P₀ denotes slurry pressure in the slurry chamber, and p denotes a penetration.

A rotational speed of the cutterhead is expressed as:

$$λ ( n ) = \frac{λ ( v )}{λ ( p )} = \frac{λ ( s )}{λ ( t ) λ ( p )}$$

where λ(n) denotes a ratio of a rotational speed of the cutterhead under the hyper-gravity to a rotational speed of the cutterhead under a normal gravity, λ(v) denotes a ratio of a tunneling speed under the hyper-gravity to a tunneling speed under the normal gravity, λ(s) denotes a ratio of a tunneling distance under the hyper-gravity to a tunneling distance under the normal gravity, λ(t) denotes a ratio of test time under the hyper-gravity to tunneling time under the normal gravity, and λ(p) denotes a ratio of a penetration under the hyper-gravity to a penetration under the normal gravity.

The pressure maintaining system includes an air inlet tube, an air exhaust tube, a pressure transducer, an air exhaust valve, and an air inlet valve; an air inlet and an air outlet are formed in the front bulkhead; one end of the air inlet tube communicates with the slurry chamber through the air inlet; another end of the air inlet tube communicates with an air outlet of the geotechnical centrifuge; one end of the air exhaust tube communicates with the slurry chamber through an air exhaust port; another end of the air exhaust tube communicates with the atmosphere; the air inlet valve and the air exhaust valve are respectively disposed on the air inlet tube and the air exhaust tube; the pressure transducer is connected to the front bulkhead; and the air inlet valve, the air exhaust valve, and the pressure transducer are connected to a control system.

A second aspect of the present disclosure provides a test method for simulating tunneling of a dual-chamber SPB shield under a hyper-gravity, including following steps:
step 1: preparing slurry with bentonite and water according to a preset ratio, injecting the slurry into the slurry box, removing the soil box from the bottom plate, preparing a soil sample in a layered manner in the soil box, and burying an earth pressure sensor in the soil sample;
step 2: saturating the soil sample in the soil box with a saturation box, and upon completion of saturation of the soil sample, hoisting the soil box into the geotechnical centrifuge, and pushing the shield body into the opening of the soil box;
step 3: turning on the slurry pump, allowing the slurry to fully fill the slurry chamber, and to reach a liquid level at two-thirds of a height of the air cushion chamber; and when the slurry seeps out from the first overflow tube and the second overflow tube, closing the third solenoid ball valve and the fourth solenoid ball valve, and stopping slurry feeding;
step 4: starting the geotechnical centrifuge, gradually increasing a centrifugal acceleration of the geotechnical centrifuge to a preset Ng value; and when the centrifugal acceleration of the geotechnical centrifuge reaches the preset Ng value, controlling the air inlet valve of the pressure maintaining system to admit air, opening the sixth solenoid valve, and maintaining the liquid level at the two-thirds of the height of the air cushion chamber; and
step 5: controlling the shield body to tunnel forward; when the shield body stably tunnels forward for a preset time period, controlling the shield body with the shield power system to stop tunneling, regulating the air pressure in the air cushion chamber by controlling the pressure maintaining system, and observing a damage condition of a contact surface between the shield body and the soil sample, thereby simulating a working condition when active and passive failures occur on the excavation face of the SPB shield under a real working condition, and obtaining a stability law of the excavation face of the SPB shield.

The technical solutions of the present disclosure have following principle:
for a prototype soil sample: σ=ρgh′,
for a 1/N-scaled model: σ₁=ρ·g·h′N, and
for a 1/N-scaled model under an N-fold hyper-gravity: σ₂=ρ·Ng·h′N=ρg h′,
where σ denotes a stress of the prototype soil sample, ρ denotes a natural density of the soil mass, g denotes a gravitational acceleration, h′ denotes a stratum depth, σ₁ denotes a stress of the 1/N-scaled model, ρ₂ denotes a stress of the 1/N-scaled model under the N-fold hyper-gravity, and N denotes a ratio of the centrifugal acceleration of the geotechnical centrifuge to the gravitational acceleration.

It can be easily observed that σ=σ₂, i.e., the stress level of the prototype soil sample is equal to that of the 1/N-scaled model under the N-fold hyper-gravity. That is, the stress field of the prototype soil sample can be reproduced under the hyper-gravity, thereby significantly improving the similarity between tunneling tests of the SPB shield.

According to the present disclosure, the shield body and the slurry feed-discharge system are fixed through the bottom plate, and placed on the geotechnical centrifuge. By creating a hyper-gravity field through centrifugal rotation, the real shield excavation process is reproduced. A variety of tube mounting ports are provided on the front bulkhead, such that slurry feed-discharge devices, pressure transmission devices, monitoring devices and the like can be connected. Considering that the slurry is circulated in the tube when the g value is increased, the cutterhead is connected to an annular stirring rod. A blade-type stirring rod is provided in the slurry box, so as to prevent segregation and sedimentation of the slurry under the hyper-gravity. The separation box is disposed on the slurry discharge tube, so as to retain large particles in the separation box under the hyper-gravity, and prevent the large particles from blocking the electromagnetic flowmeter and the tube. After the g value is stable, the SPB shield is operated to tunnel and excavate the stratum soil sample in the soil box. During this process, monitoring data of sensors are acquired in real time, so as to simulate a dynamic cutting process of the filter cake and a disturbance condition of the soil mass during actual shield tunneling. When the shield body stably tunnels forward for a preset time period, in order to simulate instability of the shield excavation face, the shield power system is used to control the shield body to stop tunneling, and the pressure maintaining system is used to regulate the air pressure. Through pressure transmission, the slurry pressure is accurately controlled, thereby obtaining an ultimate support pressure and an excavation face stability law.

The working chamber of the SPB shield is divided by the front bulkhead into the air cushion chamber and the slurry chamber. That is, the support pressure on the excavation face is divided into the air pressure and the slurry pressure. The gas pressure is regulated by the pressure maintaining system, while the slurry pressure is regulated by the slurry feed flow and the slurry discharge flow. With the hyper-gravity environment generated by the geotechnical centrifuge, according to the similarity scale relationship, the present disclosure can make the shield body to reproduce the real scale of the SPB shield, the real stress level of the stratum, and the real gradient pressure of the slurry, thereby reproducing a working condition of tunneling excavation of the SPB shield in actual engineering.

The present disclosure has the following beneficial effects:

1. The present disclosure has a high degree of mechanization and a high degree of reproduction, can simulate cutting and forward tunneling actions of the actual shield cutterhead, and can accurately control the slurry pressure, the slurry feed flow, and the slurry discharge flow in the slurry chamber.

2. With the N-fold hyper-gravity environment to conduct the tunneling excavation test and the excavation face stability test of the 1/N-fold SPB shield, the present disclosure greatly improves the similarity of the model test.

3. By providing different types of stirring rods on the cutterhead and in the slurry box, and circulating the slurry in the tube when the g value is increased, the present disclosure prevents impacts of the hyper-gravity effect on the segregation and sedimentation of the slurry.

4. The present disclosure provides the separation box and the damper on the slurry discharge tube. The present disclosure controls the slurry discharge pressure with different damper combinations, thereby controlling the slurry discharge flow. By filtering the large particles with the separation box, the present disclosure prevents the large particles from blocking the electromagnetic flowmeter and the tube.

### BRIEF DESCRIPTION OF THE DRAWINGS

FIG. 1 is a structural view of a device according to the present disclosure;

FIG. 2 is a schematic view of an internal structure of a device according to the present disclosure;

FIG. 3 is a schematic view of an internal structure of a shield body according to the present disclosure;

FIG. 4 is a schematic view of a slurry feed-discharge system;

FIG. 5 is a schematic view of a separation box;

FIG. 6 is a schematic view of a hydraulic system;

FIG. 7 is a schematic view of a pressure maintaining system;

FIG. 8 is a structural view of a cutterhead;

FIG. 9 is a schematic structural view of a screw conveyor;

FIG. 10 is a schematic view of a slurry box; and

FIG. 11 is a schematic view of a geotechnical centrifuge.

In the figure: 1: soil box, 2: shield body, 3: slurry box, 4: muck box, 5: power box, 6: drive motor, 7: slurry pump, 8: separation box, 9: screw conveyor, 10: bottom plate, 11: cutterhead, 12: slurry chamber, 13: front bulkhead, 14: air cushion chamber, 15: main shaft, 16: torque sensor, 17: first slurry inlet tube, 18: second slurry inlet tube, 19: first electromagnetic flowmeter, 20: pressure maintaining system, 21: ball guide rail, 22: oil cylinder, 23: second electromagnetic flowmeter, 24: seventh solenoid valve, 25: geotechnical centrifuge, 26: control system, 27: thin aluminum plate, 28: first overflow tube, 29: second overflow tube, 30: connecting tube, 31: third solenoid ball valve, 32: first solenoid ball valve, 33: fourth solenoid ball valve, 34: fifth solenoid ball valve, 35: second solenoid ball valve, 36: bypass ball valve, 37: sixth solenoid valve, 38: slurry tank, 39: third slurry inlet tube, 40: changeover valve block, 41: damper, 201: pressure transducer, 202: air exhaust valve, 203: air inlet valve, 301: stirring motor, 302: stirring blade, 701: gear flowmeter, 702: first proportional velocity regulating valve, 703: second proportional velocity regulating valve, 704: reversing valve, 705: relief valve, 706: two-position two-way solenoid ball valve, 707: second ball valve, 708: third rotary joint, 709: fourth rotary joint, 801: filter screen, 901: hard cylinder, 902: flexible cylinder, 903: dynamic torque sensor, 904: reducer, 905: servo motor, 111: stirring rod, 221: servo valve, 222: one-way valve, 223: filter, 224: first rotary joint, 225: first ball valve, 251: first basket, 252: counterweight, 253: second basket, 254: rotary arm, 255: air outlet, 256: oil outlet, 257: camera, 258: cable, and 259: oil return port.

### DETAILED DESCRIPTION OF THE EMBODIMENTS

The present disclosure will be further described below in conjunction with the accompanying drawings and embodiments.

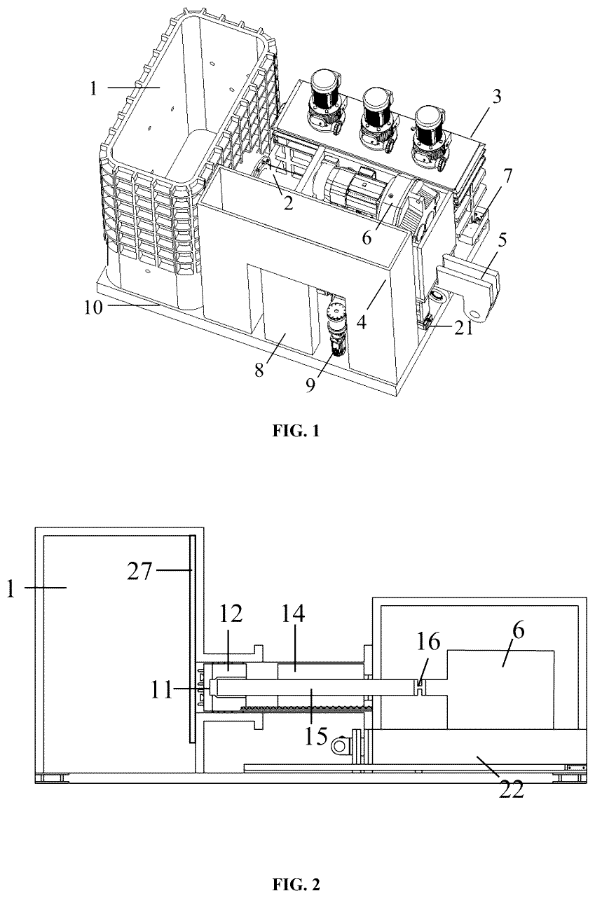

As shown in FIG. 1, a test device for simulating tunneling of a dual-chamber SPB shield under a hyper-gravity includes soil box 1, shield body 2, a shield power system, and a slurry feed-discharge system. A soil mass is stored in the soil box 1. The soil box 1 is connected to the shield power system through the shield body 2. The shield power system is configured to drive the shield body 2 to move back and forth along a tunneling direction, such that the shield body 2 performs tunneling on the soil mass in the soil box 1. The shield body 2 is connected to the slurry feed-discharge system. Slurry stored in the slurry feed-discharge system is injected into the shield body 2 through a tube. Muck generated during the tunneling is discharged from the shield body 2 to the slurry feed-discharge system through a tube. Pressure maintaining system 20 configured to balance air pressure in the shield body 2 is disposed in the shield body 2. The pressure maintaining system 20 is configured to control and regulate air pressure in air cushion chamber 14. The soil box 1, the shield power system, and the slurry feed-discharge system are fixed on bottom plate 10. The bottom plate 10 is placed into a basket of geotechnical centrifuge 25. The pressure maintaining system 20, the shield power system, and the slurry feed-discharge system are electrically connected to control system 26 outside.

As shown in FIG. 11, the geotechnical centrifuge 25 includes first basket 251, second basket 253, and a centrifuge base. The first basket 251 and the second basket 253 are respectively disposed on two sides of the centrifuge base through rotary arm 254. Counterweight 252 is placed into the first basket 251. The bottom plate 10 is fixedly disposed on the second basket 253. Camera 257 is disposed on the rotary arm 254 through which the second basket 253 is connected to the centrifuge base. Air outlet 255, oil outlet 256, and oil return port 259 are formed in the rotary arm 254.

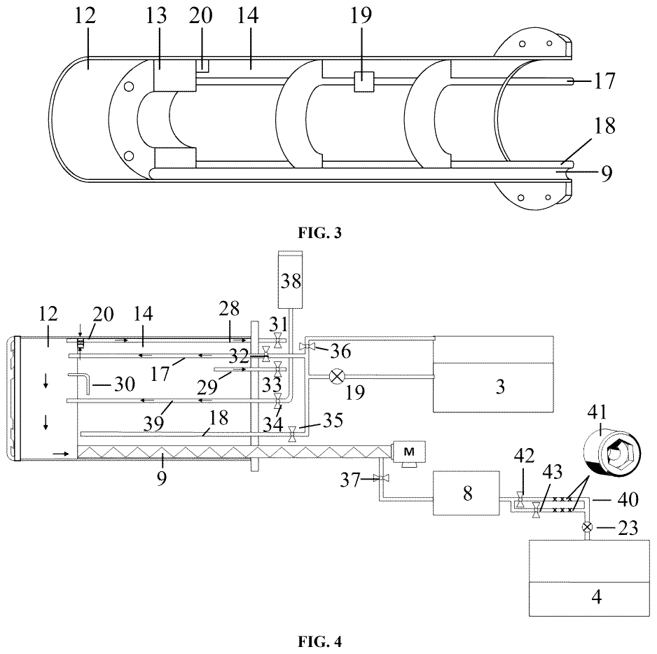

As shown in FIGS. 2-3, the shield body 2 includes a chamber housing internally provided with a working chamber, cutterhead 11, front bulkhead 13 that is annular, and main shaft 15. The front bulkhead 13 is located in the chamber housing, and configured to divide the working chamber into slurry chamber 12 and the air cushion chamber 14. The cutterhead 11 is located on a side close to the slurry chamber 12. One end of the main shaft 15 is connected to the shield power system. Another end of the main shaft 15 is coaxially connected to the cutterhead 11 after sequentially passing through the air cushion chamber 14, the front bulkhead 13, and the slurry chamber 12. An end of the chamber housing provided with the slurry chamber 12 is movably connected to an opening of the soil box 1, and can move back and forth relative to the opening of the soil box 1. An end of the chamber housing provided with the air cushion chamber 14 is fixedly connected to the shield power system. The shield power system is configured to drive the cutterhead 11 to rotate, and to drive the main shaft 15 to axially tunnel forward. Both the slurry chamber 12 and the cutterhead 11 are disposed at the opening of the soil box 1. Connecting tube 30 is connected to the front bulkhead 13. The connecting tube 30 is configured to transmit the pressure in the air cushion chamber 14 to the slurry chamber 12. Oil cylinder 22 in the shield power system is controlled in a closed-loop manner through servo valve 221 in the control system 26.

A pressure sensor is disposed on a side of the front bulkhead 13 close to the slurry chamber 12. The pressure sensor is configured to transmit an acquired slurry pressure signal to the control system 26. A connecting tube port configured to mount the connecting tube 30 is formed in the front bulkhead 13. Two ports of the connecting tube 30 respectively communicate with the slurry chamber 12 and the air cushion chamber 14. The connecting tube 30 enables air conduction between the air cushion chamber 14 and the slurry chamber 12.

The shield power system includes power box 5, drive motor 6, ball guide rail 21, and the oil cylinder 22. The ball guide rail 21 is fixed on the bottom plate 10. The oil cylinder 22 may be disposed on the ball guide rail 21 in a reciprocating manner along an extension direction of the ball guide rail 21. The power box 5 is fixedly disposed on the oil cylinder 22. The drive motor 6 is disposed in the power box 5. A sidewall of the power box 5 is fixedly connected to one end of the chamber housing. An opening serving as an outlet of the power box is formed in a sidewall of a side of the power box 5 close to the shield body 2. One end of the main shaft 15 is connected to an output shaft of the drive motor 6 through the outlet of the power box. Torque sensor 16 is disposed on an outer surface of a side of the main shaft 15 close to the drive motor 6. The torque sensor 16 is configured to transmit an acquired torque signal to the control system 26. The oil cylinder 22 is connected to the oil outlet 256 of the geotechnical centrifuge 25. The drive motor 6 is configured to drive the main shaft 15 to reach a preset torque according to an electrical signal of the torque sensor 16. The torque is then transmitted to the cutterhead 11 through the main shaft 15. The oil cylinder 22 drives the power box 5 to move forward. The power box 5 transmits a thrust to the cutterhead 11 through the main shaft 15. The oil cylinder 22 is connected to the oil outlet 256 and the oil return port 259 through a tube.

As shown in FIGS. 4-6, the slurry feed-discharge system includes slurry box 3, slurry pump 7, muck box 4, separation box 8, and screw conveyor 9. The slurry pump 7 is connected to an output end of the slurry box 3. The slurry pump 7 communicates with the slurry chamber 12 through first slurry inlet tube 17. The slurry pump 7 communicates with the air cushion chamber 14 through second slurry inlet tube 18. First solenoid ball valve 32 and second solenoid ball valve 35 are respectively disposed on the first slurry inlet tube 17 and the second slurry inlet tube 18. First electromagnetic flowmeter 19 is further disposed on the second slurry inlet tube 18. One end of first overflow tube 28 extends into the slurry chamber 12 through the air cushion chamber 14 and an opening in the front bulkhead 13. Another end of the first overflow tube 28 communicates with the atmosphere. One end of the second overflow tube 29 extends into the air cushion chamber 14. Another end of the second overflow tube 29 communicates with the atmosphere. Third solenoid ball valve 31 and fourth solenoid ball valve 33 are respectively disposed on the first overflow tube 28 and the second overflow tube 29. A bypass tube is further disposed between the slurry box 3 and the slurry pump 7. The bypass tube includes one end connected to the slurry box 3, and another end communicating with the slurry pump 7, the first slurry inlet tube 17, and the second slurry inlet tube 18. Bypass ball valve 36 is disposed on the bypass tube. The slurry chamber 12 is further connected to external slurry tank 38 through third slurry inlet tube 39. Fifth solenoid ball valve 34 is disposed on the third slurry inlet tube 39.

The screw conveyor 9 includes one end extending into the slurry chamber 12, and another end connected to the muck box 4 through a tube. Sixth solenoid valve 37, the separation box 8, and changeover valve block 40 are sequentially disposed on a tube from the screw conveyor 9 to the muck box 4. The slurry pump 7 is powered by hydraulic pressure of the geotechnical centrifuge 25.

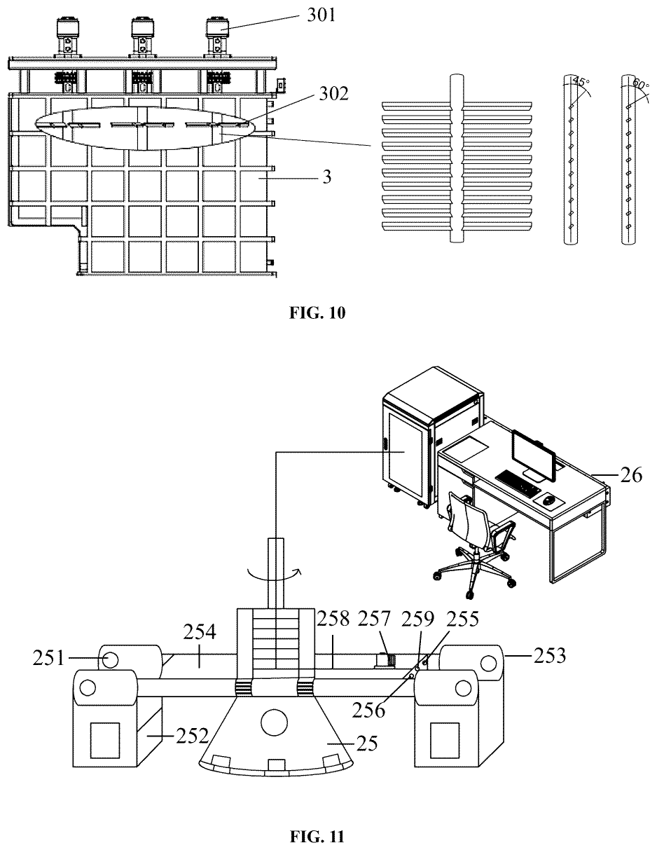

The slurry box 3, the slurry pump 7, the muck box 4, and the separation box 8 are disposed on the bottom plate 10. As shown in FIG. 10, stirring motor 301 is disposed on a top of the slurry box 3. An output shaft of the stirring motor 301 is connected to stirring blade 302. The stirring blade 302 is located in the slurry box 3 and configured to stir the slurry, preventing segregation and sedimentation of the slurry under a hyper-gravity environment. The oil outlet 256 of the geotechnical centrifuge 25 is connected to an input end of the slurry pump 7 through a tube. The slurry pump 7 is configured to feed the slurry in the slurry box 3 to the slurry chamber 12 and the air cushion chamber 14. Electromagnetic flowmeters for real-time flow monitoring are respectively disposed on the slurry inlet tubes 17, 18. The first electromagnetic flowmeter 19 is configured to transmit a signal to the control system 26 through cable 258. A slurry discharge port is formed in a bottom of the front bulkhead 13. One end of the screw conveyor 9 communicates with the slurry chamber 12 through the slurry discharge port. Another end of the screw conveyor 9 is connected to the input end of the separation box 8, and controlled by the sixth solenoid valve 37. The first overflow tube 28 is disposed on a top of the slurry chamber 12. The second overflow tube 29 is disposed at a liquid level that is two-thirds of a height from a bottom of the air cushion chamber 14. Solenoid ball valves in the slurry feed-discharge system are connected to the control system 26.

The changeover valve block 40 mainly includes two branch tubes, a muck inlet tube, and a muck outlet tube. One end of the muck inlet tube is connected to the separation box 8. Another end of the muck inlet tube is connected to input ends of the two branch tubes. Output ends of the two branch tubes are connected to one end of the muck outlet tube. Another end of the muck outlet tube is connected to the muck box 4. Seventh solenoid valve 24 and damper 41 are respectively disposed on the two branch tubes. Second electromagnetic flowmeter 23 is disposed on the muck outlet tube. A slurry discharge flow is controlled through a flow resistance of the damper 41.

The slurry discharge flow in the muck outlet tube is obtained by:

$$Q = {C}_{d} A \sqrt{\frac{2 Δ P}{{ρ}_{d}}}$$

where [symbol] denotes the slurry discharge flow, C_{d} denotes a damping coefficient of the damper 41, A denotes a cross-sectional area of the muck outlet tube, ΔP denotes a pressure drop, and ρ_{d} denotes a density of slurry mixed with muck.

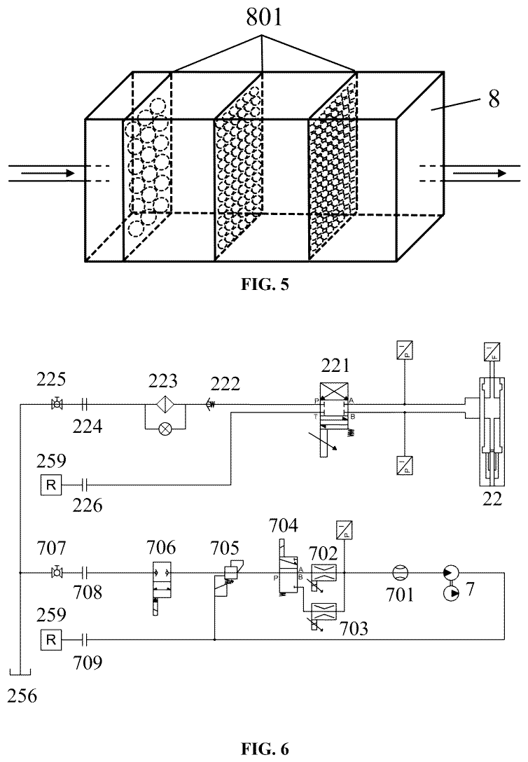

As shown in FIG. 5, three layers of filter screens 801 with different pore sizes are disposed in the separation box 8. An axial direction of each of the three layers of filter screens 801 is perpendicular to a slurry flow direction. Slurry output by the screw conveyor 9 flows from an input end of the separation box 8, is sequentially filtered by the three layers of filter screens, and flows out from the separation box 8. The pore sizes of the three layers of filter screens 801 are sequentially decreased in a direction from an inlet to an outlet of the separation box 8. A pore size of a third layer of filter screen 801 (i.e., the filter screen 801 with a minimum pore size) is less than a maximum particle size for second electromagnetic flowmeter 23. A horizontal height of the output/input end of the separation box 8 is the same as a horizontal height of the screw conveyor 9.

To guarantee stability of an excavation face in front of the cutterhead, and prevent the occurrence of active failure and passive failure, the air pressure adjusted by the pressure maintaining system shall ensure that a relationship between slurry pressure and soil-water pressure at any vertical position z of the excavation face satisfies a following formula.

The relationship between the slurry pressure and the soil-water pressure at the excavation face of the shield body 2 is expressed as:

$${P}_{g} + {ρ}_{s} g ( h - D + z ) \geq {γ}_{w} ( H + z ) + {K}_{a} {γ}^{′} ( H + z )$$

$${P}_{g} + {ρ}_{s} g ( h - D + z ) \leq {γ}_{w} ( H + z ) + {K}_{p} {γ}^{′} ( H + z )$$

where P_{g} denotes air pressure, ρₛ denotes a slurry density, g denotes a gravitational acceleration, h denotes a liquid level of the air cushion chamber, D denotes a shield diameter, z denotes a vertical coordinate of the excavation face, γ_{w} denotes a specific weight of water, H denotes a shield top buried depth, γ′ denotes an effective specific weight of soil, Kₐ denotes an active earth pressure coefficient, and Kₚ denotes a passive earth pressure coefficient.

As can be seen from γ_{w}+Kₐγ′−ρₛg>0 and γ_{w}+Kₚγ′−ρₛg>0:

$$( {γ}_{w} + {K}_{a} {γ}^{′} ) ( H + D ) - {ρ}_{s} gh \leq {P}_{g} \leq ( {γ}_{w} + {K}_{p} {γ}^{′} ) H + {ρ}_{s} g ( D - h )$$

The thrust F_{d} provided by the hydraulic oil cylinder 22 and the torque T provided by the drive motor 6 in the shield power system are obtained by:

$${F}_{d} = {F}_{1} + {F}_{2} = \frac{π}{4} {D}^{2} K γ ( H + \frac{D}{2} ) + f γ D [ \frac{π}{2} ( 1 + K ) ( H + \frac{D}{2} ) - \frac{1}{3} D ( 2 + K ) ] L + fLW$$

$$T = {T}_{1} + {T}_{2} = \frac{π}{12} {D}^{3} Kf γ ( H + \frac{D}{2} ) ( 1 - {η}^{2} ) + \frac{π}{4} {D}^{2} ( 1 + K ) f γ ( H + \frac{D}{2} ) W + {KP}_{0} \frac{{D}^{2}}{8} p$$

where F_{d} denotes the thrust provided by the shield power system, F₁ denotes a front propulsive resistance during shield tunneling, F₂ denotes a frictional force between a shield shell and a surrounding soil mass, K denotes a lateral earth pressure coefficient, Y denotes a specific weight of soil, f denotes a frictional coefficient between the shield shell and the surrounding soil mass, L denotes a length of a shield tunneling machine, W denotes a dead weight per unit length of the shield tunneling machine, T denotes the torque provided by the shield power system, T₁ denotes a frictional resistance torque between a front and a side of the cutterhead and the soil mass, T₂ denotes a stratum resistance torque when the cutterhead cuts the soil mass, η denotes an opening ratio of the cutterhead, P₀ denotes slurry pressure in the slurry chamber, and p denotes a penetration.

$$λ ( {F}_{d} ) = \frac{1}{{N}^{2}}$$

$$λ ( {T}_{1} ) = \frac{1}{{N}^{3}}$$

$$λ ( {T}_{2} ) = \frac{1}{{N}^{2}} λ ( p )$$

$$\frac{1}{N} < λ ( p ) < 1$$

where λ(F_{d}) denotes a ratio of a thrust under the hyper-gravity to a thrust under a normal gravity, N denotes an amplification factor for a gravity of a hyper-gravity test, λ(T₁) denotes a ratio of a frictional resistance torque under the hyper-gravity to a frictional resistance torque under the normal gravity, λ(T₂) denotes a ratio of a stratum resistance torque under the hyper-gravity to a stratum resistance torque under the normal gravity, and λ(p) denotes a ratio of a penetration under the hyper-gravity to a penetration under the normal gravity. A height of a cutter of a cutterhead 11 is greater than or equal to a penetration of the cutterhead 11. Since foundation soil actually cut by the shield is a continuous medium, the penetration of the cutterhead is considered as a multiple of an average particle size d₅₀ of the foundation soil, such as 20d₅₀, 30d₅₀ or 40d₅₀.

As shown in FIG. 8, a side of the cutterhead 11 close to the slurry chamber 12 is fixedly connected to stirring rod 111. The stirring rod is arranged in two ways: The stirring rod is flat, and is disposed on a panel of the cutterhead 11. Alternatively, the stirring rod is hook-like and is disposed along a circumferential direction of the main shaft 15. Through rotation of the main shaft 15, the stirring rod is driven to stir. Considering that there is a similarity scale relationship between shield tunneling parameters under the hyper-gravity and shield tunneling parameters under the normal gravity, a rotational speed of the cutterhead 11 under the hyper-gravity is expressed as:

$$λ ( n ) = \frac{λ ( v )}{λ ( p )} = \frac{λ ( s )}{λ ( t ) λ ( p )}$$

where λ(n) denotes a ratio of a rotational speed of the cutterhead under the hyper-gravity to a rotational speed of the cutterhead under the normal gravity, λ(v) denotes a ratio of a tunneling speed under the hyper-gravity to a tunneling speed under the normal gravity, λ(s) denotes a ratio of a tunneling distance under the hyper-gravity to a tunneling distance under the normal gravity, and λ(t) denotes a ratio of test time under the hyper-gravity to tunneling time under the normal gravity.

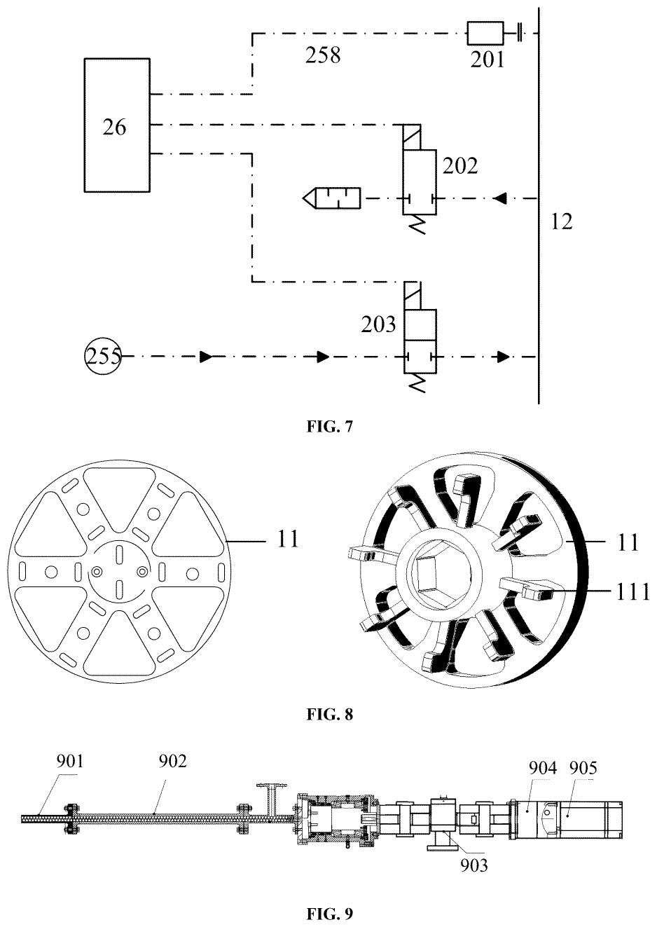

As shown in FIG. 7, the pressure maintaining system 20 includes an air inlet tube, an air exhaust tube, pressure transducer 201, air exhaust valve 202, and air inlet valve 203. An air inlet and an air outlet are formed in the front bulkhead 13. One end of the air inlet tube communicates with the slurry chamber 12 through the air inlet. Another end of the air inlet tube communicates with the air outlet 255 of the geotechnical centrifuge 25. One end of the air exhaust tube communicates with the slurry chamber 12 through an air exhaust port. Another end of the air exhaust tube communicates with the atmosphere. The air inlet valve 203 and the air exhaust valve 202 are respectively disposed on the air inlet tube and the air exhaust tube. The pressure transducer 201 is connected to the front bulkhead 13, and configured to measure air pressure in the air cushion chamber 14. The air inlet valve 203, the air exhaust valve 202, and the pressure transducer 201 are connected to the control system 26 through the cable 258. The control system 26 is configured to control an opening degree of the air exhaust valve 202 and an opening degree of the air inlet valve 203, thereby controlling an air inflow in the air inlet tube and an air outflow in the air exhaust tube.

The oil cylinder 22 is controlled in the closed-loop manner with the servo valve 221: The oil outlet 256 of the geotechnical centrifuge 25 is connected to an input end of a first ball valve 225. An output end of the first ball valve 225 is connected to oil inlet P of the servo valve 221 through a tube. First rotary joint 224, filter 223, and one-way valve 222 are sequentially disposed on a tube from the first ball valve 225 to the servo valve 221. Oil return port T of the servo valve 221 is connected to the oil return port 259 through second rotary joint 226. Oil outlet B of the servo valve 221 is connected to the oil cylinder 22. The filter 223 is configured to prevent metal debris generated by the rotary joint from damaging the servo valve 221 in the control system 26. The three-position four-way servo valve 221 can realize a reversing function.

The slurry pump 7 is powered by the hydraulic pressure of the geotechnical centrifuge 25. The oil outlet 256 of the geotechnical centrifuge 25 is connected to an input end of second ball valve 707 through a tube. An output end of the second ball valve 707 is connected to an oil inlet of the slurry pump 7 through a tube. Third rotary joint 708, two-position two-way solenoid ball valve 706, relief valve 705, reversing valve 704, proportional velocity regulating valves 702, 703, and gear flowmeter 701 are sequentially disposed on a tube from the second ball valve 707 to the slurry pump 7. An oil return port of the slurry pump 7 is connected to the oil return port 259 of the geotechnical centrifuge 25 through fourth rotary joint 709. The relief valve 705 is configured to balance rated working pressures of the slurry pump 7 and the oil cylinder 22. An oil return port of the relief valve 705 is connected to an input end of the fourth rotary joint 709.

As shown in FIG. 9, the screw conveyor 9 includes hard cylinder 901, flexible cylinder 902, and servo motor 905. The hard cylinder 901 extends into the slurry chamber 12. The flexible cylinder 902 is disposed in the air cushion chamber 14 and communicates with the separation box 8. The hard cylinder 901 mainly includes a first cylindrical wall and a first spiral blade. The first spiral blade is rotatably disposed in the first cylindrical wall. The flexible cylinder 902 mainly includes a second cylindrical wall and a second spiral blade. The second spiral blade is rotatably disposed in the second cylindrical wall. The first cylindrical wall is coaxially and fixedly connected to the second cylindrical wall. The first spiral blade is coaxially and fixedly connected to one end of the second spiral blade. An output shaft of the servo motor 905 is coaxially and fixedly connected to another end of the second spiral blade through a shaft coupling and reducer 904. The servo motor 905 is configured to drive the first spiral blade and the second spiral blade to rotate, thereby preventing blockage of the screw conveyor 9. Dynamic torque sensor 903 configured to monitor a torque of the screw conveyor 9 is disposed on the shaft coupling connected to the servo motor 905.

The embodiment of the present disclosure includes following steps:

Preliminary preparation: Shield parameters, including the shield diameter, the shield buried depth, the tunneling speed, and the rotational speed of the cutterhead, are determined. According to the shield diameter, the shield buried depth, and a foundation soil-water pressure, the target Ng value to be provided by the geotechnical centrifuge 25 is determined, thereby determining the air pressure of the air cushion chamber 14. According to a ratio 1:11.7 of a volume of muck cut by the cutterhead 11 in unit time to a slurry feed flow, in combination with the tunneling speed, the slurry feed flow is determined. Based on the mass conservation relationship, the slurry discharge flow is determined. The discharge flow rate is calculated according to the slurry pressure in the slurry chamber 12. A calculated value is compared with a preset value to determine a size of the damper 41.

Step 1: Slurry is prepared with bentonite and water according to a preset ratio, the slurry is injected into the slurry box 3 of the slurry feed-discharge system, the soil box 1 is removed from the bottom plate 10, an opening on a sidewall of the soil box is sealed with thin aluminum plate 27, a soil sample is prepared in a layered manner in the soil box 1, and an earth pressure sensor is buried in the soil sample.

During specific implementation, a bender element sensor, a micro-earth pressure cell, a micro-pore pressure sensor, and a time-domain reflectometer (TDR) sensor are further buried in the soil sample. A top of the foundation soil is roughened by 2 mm with a steel wire brush.

Step 2: The soil sample in the soil box 1 is saturated with a saturation box. Upon completion of saturation of the soil sample, the soil box 1 is hoisted into the geotechnical centrifuge 25, and the shield body 2 is pushed into the opening of the soil box 1. With the cutterhead 11 propping against the thin aluminum plate 27, a slurry discharge tube is closed.

Specifically, the soil box 1 is placed into the saturation box. Air-free water in the saturation box is pumped into the soil box 1 in a vacuum pumping manner. After the air-free water is pumped completely, the soil box 1 is fixed again on the bottom plate 10. The counterweight 252 is hoisted into the first basket 251. The bottom plate 10 is hoisted into the second basket 253.

Step 3: The slurry pump 7 is turned on, allowing the slurry to fully fill the slurry chamber 12 through the slurry inlet tubes 17, 18, and to reach the liquid level at the two-thirds of the height of the air cushion chamber 14. When the slurry seeps out from the first overflow tube 28 and the second overflow tube 29 in the slurry feed-discharge system, the third solenoid ball valve 31 and the fourth solenoid ball valve 33 are closed, and slurry feeding is stopped. At this time, the slurry pressure in the shield body 2 is 0-2.5 kPa.

The slurry tank 38 and the third slurry inlet tube 39 are mounted. The fifth solenoid ball valve 34 on the third slurry inlet tube 39 is opened. The height and the liquid level of the slurry tank 38 are controlled, such that the pressure of the slurry chamber 12 is slightly higher than a lateral soil-water pressure of the soil sample in the soil box 1. The thin aluminum plate 27 is lifted such that pressurized slurry in the slurry chamber 14 permeates a soil layer. When a filter cake is formed, the fifth solenoid ball valve 34 is closed, and the slurry tank 38 and the third slurry inlet tube 39 are removed.

Step 4: The geotechnical centrifuge 25 is started. A centrifugal acceleration of the geotechnical centrifuge 25 is gradually increased to a preset Ng value. When the centrifugal acceleration is increased, all solenoid ball valves (the first solenoid ball valve 32, the second solenoid ball valve 35, the third solenoid ball valve 31, the fourth solenoid ball valve 33, and the sixth solenoid valve 37) are closed, and the slurry is maintained to fully fill the slurry chamber 12 and the air cushion chamber 14. The slurry pressure in the slurry chamber 12 increases constantly with increase of the acceleration Ng value. When the centrifugal acceleration is increased, the cutterhead 11 performs idle rotation, so as to prevent segregation and sedimentation of the slurry in the slurry chamber 12. Meanwhile, the stirring rod 302 in the slurry box 3 continues to stir, so as to prevent the segregation and sedimentation of the slurry in the slurry box 3. The slurry pump 7 is turned on and the bypass ball valve 36 is opened, such that the slurry is circulated in a tube connected to the slurry box 3 to prevent segregation and sedimentation in the tube. When the centrifugal acceleration of the geotechnical centrifuge 25 reaches the preset Ng value, the air inlet valve 203 of the pressure maintaining system 20 is controlled to admit air, the sixth solenoid valve 37 is opened, and the liquid level of the air cushion chamber 14 is maintained at the two-thirds of the height of the air cushion chamber 14. The damper 41 is set according to a variation of the liquid level of the air cushion chamber 14 and a theoretical value of the slurry pressure.

Step 5: The shield body 2 is controlled to tunnel forward. When the shield body 2 stably tunnels forward for a preset time period, the shield body 2 is controlled with the shield power system to stop tunneling, valves on all tubes are closed, and the air pressure in the air cushion chamber 14 is regulated by controlling the pressure maintaining system 20. A damage condition of a contact surface between the shield body 2 and the soil sample is observed, thereby simulating a working condition when active and passive failures occur on the excavation face of the SPB shield under a real working condition, and obtaining a stability law of the excavation face of the SPB shield.

1. A test device for simulating tunneling of a dual-chamber slurry pressure balance (SPB) shield under a hyper-gravity, comprising:
a soil box (1), a shield body (2), a shield power system, and a slurry feed-discharge system, wherein a soil mass is stored in the soil box (1); the soil box (1) is connected to the shield power system through the shield body (2); the shield power system is configured to drive the shield body (2) to move back and forth along a tunneling direction, and then the shield body (2) performs tunneling on the soil mass in the soil box (1); the shield body (2) is connected to the slurry feed-discharge system; a pressure maintaining system (20) configured to balance air pressure in the shield body (2) is disposed in the shield body (2); the soil box (1), the shield power system, and the slurry feed-discharge system are fixed on a bottom plate (10); and the bottom plate (10) is placed into a basket of a geotechnical centrifuge (25);
the slurry feed-discharge system comprises a slurry box (3), a slurry pump (7), a muck box (4), a separation box (8), and a screw conveyor (9); the slurry pump (7) is connected to an output end of the slurry box (3); the slurry pump (7) communicates with the slurry chamber (12) through a first slurry inlet tube (17); the slurry pump (7) communicates with the air cushion chamber (14) through a second slurry inlet tube (18); a first solenoid ball valve (32) and a second solenoid ball valve (35) are respectively disposed on the first slurry inlet tube (17) and the second slurry inlet tube (18); one end of a first overflow tube (28) extends into the slurry chamber (12) through the air cushion chamber (14) and an opening in the front bulkhead (13); another end of the first overflow tube (28) communicates with the atmosphere; one end of the second overflow tube (29) extends into the air cushion chamber (14); another end of the second overflow tube (29) communicates with the atmosphere; a third solenoid ball valve (31) and a fourth solenoid ball valve (33) are respectively disposed on the first overflow tube (28) and the second overflow tube (29); a bypass tube is further disposed between the slurry box (3) and the slurry pump (7); the bypass tube comprises one end connected to the slurry box (3), and another end communicating with the slurry pump (7), the first slurry inlet tube (17), and the second slurry inlet tube (18); and a bypass ball valve (36) is disposed on the bypass tube;
the screw conveyor (9) comprises one end extending into the slurry chamber (12), and another end connected to the muck box (4) through a tube; a sixth solenoid valve (37), the separation box (8), and a changeover valve block (40) are sequentially disposed on a tube from the screw conveyor (9) to the muck box (4); and the slurry pump (7) is powered by hydraulic pressure of the geotechnical centrifuge (25);
the changeover valve block (40) is mainly composed of two branch tubes, a muck inlet tube, and a muck outlet tube; one end of the muck inlet tube is connected to the separation box (8); another end of the muck inlet tube is connected to input ends of the two branch tubes; output ends of the two branch tubes are connected to one end of the muck outlet tube; another end of the muck outlet tube is connected to the muck box (4); a seventh solenoid valve (24) and a damper (41) are respectively disposed on the two branch tubes; and a second electromagnetic flowmeter (23) is disposed on the muck outlet tube; and
a slurry discharge flow in the muck outlet tube is obtained by:
$$Q = {C}_{d} A \sqrt{\frac{2 Δ P}{{ρ}_{d}}}$$
wherein [symbol] denotes the slurry discharge flow, C_{d} denotes a damping coefficient of the damper (41), A denotes a cross-sectional area of the muck outlet tube, ΔP denotes a pressure drop, and ρ_{d} denotes a density of slurry mixed with muck.

2. The test device for simulating tunneling of a dual-chamber SPB shield under a hyper-gravity according to claim 1, wherein the shield body (2) comprises a chamber housing internally provided with a working chamber, a cutterhead (11), the annular front bulkhead (13), and a main shaft (15); the front bulkhead (13) is located in the chamber housing, and configured to divide the working chamber into the slurry chamber (12) and the air cushion chamber (14); the cutterhead (11) is located on a side close to the slurry chamber (12); one end of the main shaft (15) is connected to the shield power system; another end of the main shaft (15) is coaxially connected to the cutterhead (11) after sequentially passing through the air cushion chamber (14), the front bulkhead (13), and the slurry chamber (12); an end of the chamber housing provided with the slurry chamber (12) is movably connected to an opening of the soil box (1), and is capable of moving back and forth relative to the opening of the soil box (1); an end of the chamber housing provided with the air cushion chamber (14) is fixedly connected to the shield power system; the shield power system is configured to drive the cutterhead (11) to rotate, and to drive the main shaft (15) to axially tunnel forward; both the slurry chamber (12) and the cutterhead (11) are disposed at the opening of the soil box (1); a connecting tube (30) is connected to the front bulkhead (13); the connecting tube (30) is configured to transmit pressure in the air cushion chamber (14) to the slurry chamber (12); and the shield power system is controlled in a closed-loop manner through a servo valve (221).

3. The test device for simulating tunneling of a dual-chamber SPB shield under a hyper-gravity according to claim 1, wherein three filter screens (801) with different pore sizes are disposed in the separation box (8); an axial direction of the filter screens (801) is perpendicular to a slurry flow direction; slurry output by the screw conveyor (9) flows from an input end of the separation box (8), is sequentially filtered by the three filter screens, and flows out from the separation box (8); the pore sizes of the three filter screens (801) are sequentially decreased in a direction from an inlet to an outlet of the separation box (8); and a pore size of the third filter screen (801) is less than a maximum particle size for the second electromagnetic flowmeter (23).

4. The test device for simulating tunneling of a dual-chamber SPB shield under a hyper-gravity according to claim 1, wherein a relationship between slurry pressure and soil-water pressure at an excavation face of the shield body (2) is expressed as:
$${P}_{g} + {ρ}_{s} g ( h - D + z ) \geq {γ}_{w} ( H + z ) + {K}_{a} {γ}^{′} ( H + z )$$
$${P}_{g} + {ρ}_{s} g ( h - D + z ) \leq {γ}_{w} ( H + z ) + {K}_{p} {γ}^{′} ( H + z )$$
wherein P_{g} denotes air pressure, ρₛ denotes a slurry density, g denotes a gravitational acceleration, h denotes a liquid level of the air cushion chamber, D denotes a shield diameter, z denotes a vertical coordinate of the excavation face, γ_{w} denotes a specific weight of water, H denotes a shield top buried depth, γ′ denotes an effective specific weight of soil, Kₐ denotes an active earth pressure coefficient, and Kₚ denotes a passive earth pressure coefficient.

5. The test device for simulating tunneling of a dual-chamber SPB shield under a hyper-gravity according to claim 1, wherein a thrust F_{d} and a torque T provided by the shield power system are obtained by:
$${F}_{d} = {F}_{1} + {F}_{2} = \frac{π}{4} {D}^{2} K γ ( H + \frac{D}{2} ) + f γ D [ \frac{π}{2} ( 1 + K ) ( H + \frac{D}{2} ) - \frac{1}{3} D ( 2 + K ) ] L + fLW$$
$$T = {T}_{1} + {T}_{2} = \frac{π}{12} {D}^{3} Kf γ ( H + \frac{D}{2} ) ( 1 - {η}^{2} ) + \frac{π}{4} {D}^{2} ( 1 + K ) f γ ( H + \frac{D}{2} ) W + {KP}_{0} \frac{{D}^{2}}{8} p$$
wherein F₁ denotes a front propulsive resistance during shield tunneling, F₂ denotes a frictional force between a shield shell and a surrounding soil mass, K denotes a lateral earth pressure coefficient, γ denotes a specific weight of soil, f denotes a frictional coefficient between the shield shell and the surrounding soil mass, L denotes a length of a shield tunneling machine, W denotes a dead weight per unit length of the shield tunneling machine, T₁ denotes a frictional resistance torque between the cutterhead and the soil mass, T₂ denotes a stratum resistance torque when the cutterhead cuts the soil mass, η denotes an opening ratio of the cutterhead, P₀ denotes slurry pressure in the slurry chamber, and P denotes a penetration.

6. The test device for simulating tunneling of a dual-chamber SPB shield under a hyper-gravity according to claim 2, wherein a rotational speed of the cutterhead (11) is expressed as:
$$λ ( n ) = \frac{λ ( v )}{λ ( p )} = \frac{λ ( s )}{λ ( t ) λ ( p )}$$
wherein λ(n) denotes a ratio of a rotational speed of the cutterhead under the hyper-gravity to a rotational speed of the cutterhead under a normal gravity, λ(v) denotes a ratio of a tunneling speed under the hyper-gravity to a tunneling speed under the normal gravity, λ(s) denotes a ratio of a tunneling distance under the hyper-gravity to a tunneling distance under the normal gravity, λ(t) denotes a ratio of test time under the hyper-gravity to tunneling time under the normal gravity, and λ(p) denotes a ratio of a penetration under the hyper-gravity to a penetration under the normal gravity.

7. The test device for simulating tunneling of a dual-chamber SPB shield under a hyper-gravity according to claim 1, wherein the pressure maintaining system (20) comprises an air inlet tube, an air exhaust tube, a pressure transducer (201), an air exhaust valve (202), and an air inlet valve (203); an air inlet and an air outlet are formed in the front bulkhead (13); one end of the air inlet tube communicates with the slurry chamber (12) through the air inlet; another end of the air inlet tube communicates with an air outlet (255) of the geotechnical centrifuge (25); one end of the air exhaust tube communicates with the slurry chamber (12) through an air exhaust port; another end of the air exhaust tube communicates with the atmosphere; the air inlet valve (203) and the air exhaust valve (202) are respectively disposed on the air inlet tube and the air exhaust tube; the pressure transducer (201) is connected to the front bulkhead (13); and the air inlet valve (203), the air exhaust valve (202), and the pressure transducer (201) are connected to a control system (26).

8. A test method for simulating tunneling of a dual-chamber slurry pressure balance (SPB) shield under a hyper-gravity applied to the test device according to any one of claims 1 to 7, comprising following steps:
step 1: preparing slurry with bentonite and water according to a preset ratio, injecting the slurry into the slurry box (3), removing the soil box (1) from the bottom plate (10), preparing a soil sample in a layered manner in the soil box (1), and burying an earth pressure sensor in the soil sample;
step 2: saturating the soil sample in the soil box (1) with a saturation box, and upon completion of saturation of the soil sample, hoisting the soil box (20) into the geotechnical centrifuge (25), and pushing the shield body (2) into the opening of the soil box (1);
step 3: turning on the slurry pump (7), allowing the slurry to fully fill the slurry chamber (12), and to reach a liquid level at two-thirds of a height of the air cushion chamber (14); and when the slurry seeps out from the first overflow tube (28) and the second overflow tube (29), closing the third solenoid ball valve (31) and the fourth solenoid ball valve (33), and stopping slurry feeding;
step 4: starting the geotechnical centrifuge (25), gradually increasing a centrifugal acceleration of the geotechnical centrifuge (25) to a preset Ng value; and when the centrifugal acceleration of the geotechnical centrifuge (25) reaches the preset Ng value, controlling the air inlet valve (203) of the pressure maintaining system (20) to admit air, opening the sixth solenoid valve (37), and maintaining the liquid level at the two-thirds of the height of the air cushion chamber (14); and
step 5: controlling the shield body (2) to tunnel forward; when the shield body (2) stably tunnels forward for a preset time period, controlling the shield body (2) with the shield power system to stop tunneling, regulating the air pressure in the air cushion chamber (14) by controlling the pressure maintaining system (20), and observing a damage condition of a contact surface between the shield body (2) and the soil sample, thereby simulating a working condition when active and passive failures occur on the excavation face of the SPB shield under a real working condition, and obtaining a stability law of the excavation face of the SPB shield under the real working condition.
